(19) United States
(12) Patent Application Publication
(10) Pub. No.: US 2006/0190959 A1
(43) Pub. Date: Aug. 24, 2006

(54) Method of presenting a customized sequence of video segments

(76) Inventors: Annemarie Gatti, Accord, NY (US); Steven Okin, Los Angeles, CA (US); Shelley Brady Koontz, Tulsa, OK (US)

Correspondence Address: MAYER & WILLIAMS PC, 251 NORTH AVE. WEST, 2ND FLOOR, WESTFIELD, NJ, 07090, US

(21) Appl. No.: 11/268,764

(22) Filed: Nov. 7, 2005

Related U.S. Application Data
(60) Provisional application No. 60/625,503, filed on Nov. 5, 2004.

(51) Int. Cl. H04N 7/16; G06F 13/00; H04N 5/445; H04N 7/173; H04H 9/00; G06F 3/00

(52) U.S. Cl. 725/13; 725/24; 725/37

(57) ABSTRACT

A method of navigating through an interactive multimedia program stored in a digital storage medium, including a plurality of tracks, includes the steps of presenting an interactive selection main menu to a viewer, presenting a first question to the viewer in response to a selection from the main menu, the question requesting an indication of a first set of parameters desired by the viewer, presenting a second question to the viewer requesting a second set of parameters desired by the viewer, and presenting a third question to the viewer requesting a third set of parameters desired by the viewer. A plurality of tracks are selected and presented in a sequential order determined at least in part by the viewer selections to the first, second and third questions. Each of the plurality of tracks is associated with at least one of a plurality of predefined categories. While the predetermined categories from which the tracks are selected are determined based on the viewer selections, the selections of tracks from within each category may be random.

### STATEMENT OF RELATED APPLICATION

This application claims the benefit of co-pending U.S. Provisional Patent Application No. 60/625,503, filed Nov. 5, 2004, entitled “One Minute Workout,” which is incorporated herein by reference in its entirety.

### FIELD OF THE INVENTION

The present invention relates generally to a method of presenting a customized sequence of video segments using a multimedia program stored in a digital storage medium, and, more specifically, to method of presenting customized random sequential video segments, using interactive DVD software, in accordance with input user selections.

### BACKGROUND OF THE INVENTION

A DVD (Digital Versatile Disc or Digital Video Disc) is a random access optical disc similar in physical dimensions to a CD but with substantially more data storage capacity. The DVD format includes high-quality video and audio, together with interactive navigation with menus and programmable control. For example, many DVDs include subtitles and/or closed captioning (in a plurality of languages), multiple camera angles, the capability to play one of a plurality of different content versions (e.g., a director's cut or unrated version and a “PG” rated version), outtakes, commentaries, interviews and games. All of these additional features are made possible by the fact that DVDs are not simply recordings of media—they are actually specialized computer programs run by the computers embedded in DVD players. The actual media content is organized and presented by the software.

Devices capable of playing DVDs provide for, among other features, capabilities for fast-forwarding, fast rewinding, skipping forward to the beginning of the next chapter, skipping backwards to the beginning of the current chapter, skipping to a previous chapter, turning on/off the subtitles, and, if turned on, selecting the language of the subtitle, selecting the language of the audio, and selecting the camera angles.

However, even with all of the capabilities and functions specified, DVDs do not fully realize the potential of a randomly accessible digital video, audio and data format, that allows a user to pre-program an interactive DVD, such that the user selects and determines broad parameters that allow the DVD to select segments from certain buckets (in which segments have a common factor) in a predetermined sequence.

### SUMMARY OF THE INVENTION

In contrast to the passive playing of a video, such as in the viewing of a motion picture or workout DVD, a primary element of a method described herein is the incorporation of the capabilities and functions that allow a user to customize viewing of an interactive DVD, such that the particular viewing desires of the user may be satisfied. The method delivers to each viewer a more enjoyable video experience by allowing the user to select broad parameters which determine, at least, the content, duration and sequence of the video segments displayed.

In accordance with the present invention, a method is provided for navigating through an interactive multimedia program stored in a digital storage medium including a plurality of tracks. The method includes the steps of presenting an interactive selection main menu and then presenting first, second and third questions to the viewer, requesting an indication of a set of parameters desired by the viewer. A plurality of tracks are selected and presented in a sequential order determined at least in part by the viewer selections to the first, second and third questions. Each of the plurality of tracks is associated with at least one of a plurality of predefined categories. While the predefined categories from which the tracks are selected are determined based on the viewer selections, the selections of tracks from within each category may be random.

In one embodiment of the invention, the digital storage medium is a DVD.

In another embodiment of the invention, the plurality of tracks presented encompass a workout video. The first question requests input from the viewer as to a desired area of concentration for the workout, such as the upper body, lower body, abdominals or total body, the second question requests input from the viewer as to a desired level of intensity for the workout and the third question requests input from the viewer as to a desired amount of minutes for the workout.

In still a further embodiment of the invention the method includes presenting a warm-up and/or cool-down track, which may be selected either randomly or based on the viewer selections.

### BRIEF DESCRIPTION OF THE DRAWINGS

FIG. 1 shows an illustration of a first embodiment of a main menu screen presented to a viewer to navigate an interactive multimedia program stored in a digital storage medium;

FIG. 2 shows an illustration of a first question presented to a viewer in response to a selection from the main menu of FIG. 1;

FIG. 3 shows an illustration of a second question presented to a viewer in response to a selection from the screen illustrated in FIG. 2;

FIG. 4 shows an illustration of a third question presented to a viewer in response to a selection from the screen illustrated in FIG. 3;

FIG. 5 shows an illustration of a special feature menu presented to a viewer in response to a selection from the main menu of FIG. 1;

FIG. 6 shows an illustration of a second embodiment of a main menu screen presented to a viewer to navigate an interactive multimedia program stored in a digital storage medium;

FIG. 7 is a flowchart illustrating the methodology described in FIGS. 1-4, in which a viewer selects an upper body concentration;

FIG. 8 is a flowchart illustrating the methodology described in FIGS. 1-4, in which a viewer selects an abdominal concentration;

FIG. 9 is a flowchart illustrating the methodology described in FIGS. 1-4, in which a viewer selects a lower body concentration;

FIG. 10 is a flowchart illustrating the methodology described in FIGS. 1-4, in which a viewer selects a total body workout;

### DETAILED DESCRIPTION

A method is proposed for navigating through an interactive multimedia program, having a plurality of tracks, and stored in a digital storage medium, such as an optical storage medium or a DVD. For example, a DVD includes multiple video streams that can be switched between seamlessly. The DVD format includes an authoring architecture in which discrete exercise segments, or each of a plurality of tracks, are assigned to one of a plurality of ‘buckets’ (or predefined categories) according to a specific workout area (for example, the ‘chest bucket/category’ (part of the upper body workout)). The remaining ‘buckets’ may include back, arms, advanced arms, squat/lunge, right leg/back leg, abdominals, advanced abdominals, and total body. This allows a user, with minimal input, to create a customized workout.

Any known authoring software may be used to create the digital storage medium—e.g., a DVD—the authoring software providing a digital storage medium with a navigational structure through which the proposed method navigates. The DVD video format for example, is one of a number of formats within the general category of interactive multimedia. These formats are capable of presenting motion or still images, along with accompanying sound, to a viewer on a display. The media are referred to as ‘interactive’ because they allow the presentation to vary depending upon input from the viewer.

The “assets”—the video and audio clips, still images, subtitles, and menu and button graphics—are laid out into tracks, streams and chapters—and interactive menus are designed linking the elements into the navigational structure. The “tracks” describe a single sequential piece of material, such as a video clip, in a DVD that is then connected by navigational links. The term “navigation” is used to refer to the flow of playback through different elements of the DVD—including menus, tracks and chapters within video clips—i.e., the playback path through the material available to be played is altered according to the choices or ‘navigation’ of the viewer. Navigation may be controlled by the viewer by menu selections (a “button” that is linked with a clip, graphic or another menu, may be used in menus to make navigation easier), can be defined when the DVD production is authored (such as returning to a menu after playback reaches the end of a clip), or can be controlled dynamically by navigational commands.

In accordance with the navigation method of present invention, a viewer is initially presented with an interactive main menu screen to create a desired presentation of a playback sequence of a series of tracks. The main menu allows the viewer to navigate the digital storage medium (e.g., DVD) and launch a series of video clips or graphics, or an additional menu.

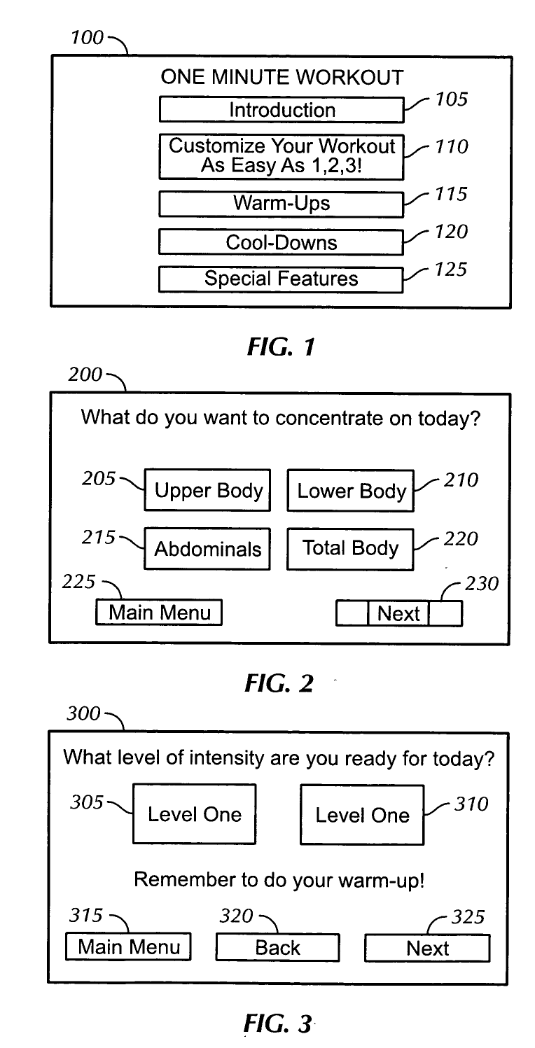

For example, as illustrated in FIG. 1, a main menu 100 entitled “one minute workout” includes various buttons that may be user-activated. The main menu 100 as shown includes introduction button 105, customize your workout button 110, warm-ups button 115, cool-downs button 120 and special features button 125. Activation of the introduction button 105 provides an instructional introduction to the use of the “one minute workout”, and may also include reminders to warm-up and cool-down before and after the workout, respectively. It may also include special feature descriptions and bonus disc outlines. Upon completion of the introduction, the digital storage medium software again presents the main menu 100 to the viewer.

Button 110 on the main menu 100 activates a first question of a possible series of questions presented to customize a workout for the user (while the exemplary embodiment described herein includes three questions to the viewer, those skilled in the art will appreciate that any number of questions could be implemented to determine a viewer's desires for a customized selection and presentation order of tracks).

FIG. 2 illustrates screen 200 that is displayed upon activation of button 110 on screen 100—and specifically, presents a first question to the user as to “what do you want to concentrate on today” (i.e., the upper body, lower body, abdominals or total body). The corresponding buttons 205, 210, 215 and 220, may each include action photos to illustrate the corresponding area of concentration. Also included on screen 200 are buttons 225 to return to the main menu 100 if desired, and button 230 to advance to the next question (of course, a default position may be included in the DVD software, such that if the user activates button 230 to advance to the next question without selecting one of the 4 areas of concentration listed, a total body workout, or any other default position, will be displayed).

FIG. 3 illustrates screen 300, and presents a second question to the user as to “what level of intensity are you ready for today” (i.e., level one 305 or level two 310). Again, the corresponding buttons 305 and 310 may include action photos to illustrate the corresponding level of intensity for each button.

Also again included On screen 300 are buttons 315 to return to the main menu 100 if desired, button 320 to return to screen 200 to select the area of concentration, and button 325 to advance to the next question (of course, again a default position may be included in the DVD software, such that if the user activates button 325 to advance to the next question without selecting one of the levels of intensity listed, a level one or level two default position will be displayed.

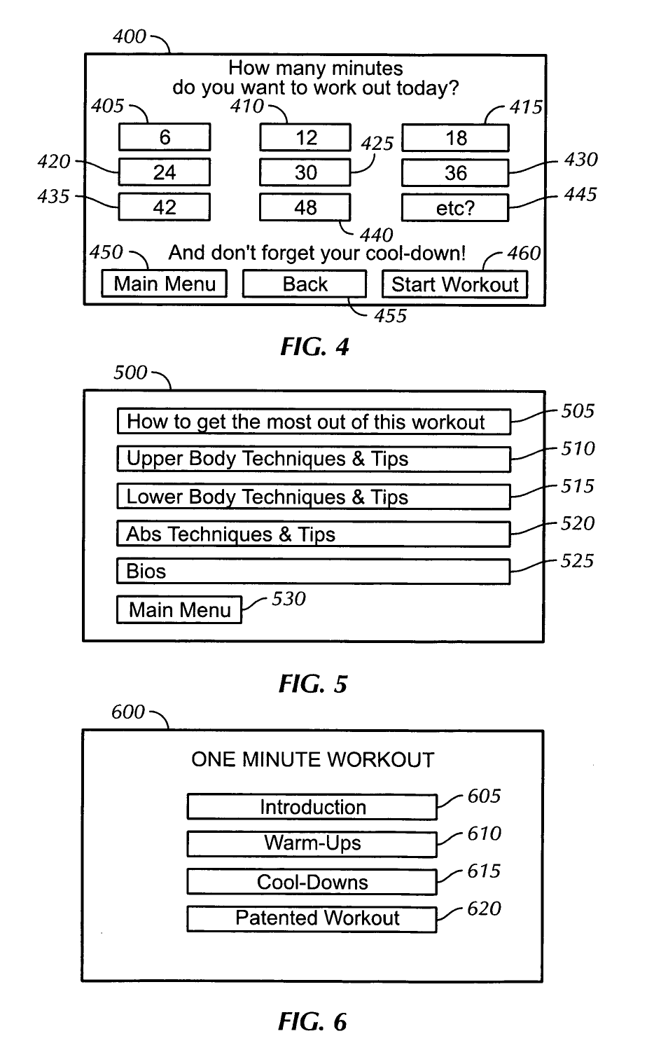

Finally, FIG. 4 illustrates screen 400, and presents a third question to the user as to “how many minutes do you want to workout today” (i.e., “6, 12, 18, 24, 30, 36, 42, 48, etc”, corresponding to buttons 405, 410, 415, 420, 425, 430, 435, 440 and 445, respectively). The specific indication as to minutes listed would depend upon both the target area selected in the first question and the level of intensity selected in the second question presented to the user. Included on screen 400 are buttons 450 to return to the main menu 100, button 455 to return to screen 300, and button 460 to begin the customized workout programmed in accordance with the selections made in questions one through three.

FIG. 5 provides an illustration of the “special features” screen 500 presented to the user upon selection of button 125 on the main menu 100 of FIG. 1. Some examples of what might be included in the special features are listed as “how to get the most out of this workout” (button 505), “upper body techniques and tips” (button 510), “lower body techniques and tips” (button 515), “abdominals techniques and tips” (button 520), “bios” (button 525) and a button 530 to return to the main menu. Each of the “techniques and tips” features (buttons 505, 510, 515 and 520) may be either a video or text presentation to the user, and the bios include a graphic/text presentation to the user.

Returning to FIG. 1 and main menu 100, selection by the user of warm-ups button 115, will begin one of the programmed warm-up segments, and selection by the user of cool-downs button 120, will begin one of the programmed cool-down segments. The warm-up and cool-down segments will be randomly selected from the plurality of segments within each respective bucket. However, in an alternate embodiment, the digital storage medium may automatically incorporate either or both of the warm-up and cool-down segments into all customized workout programs created in accordance with the user's selections in answer to questions one through three,

FIG. 6 illustrates a main menu 600 of another embodiment of the invention. Again the main menu is entitled “one minute workout” includes various buttons that may be user-activated. The main menu 600 as shown includes introduction button 605, warm-ups button 610, cool-downs button 615 and patented workout 620. As described above, activation of the introduction button 605 provides an instruction introduction to the use of the “one minute workout”, and may also include reminders to warm-up and cool-down before and after the workout, respectively. Upon completion of the introduction, the DVD software returns and presents the main menu 600 once again.

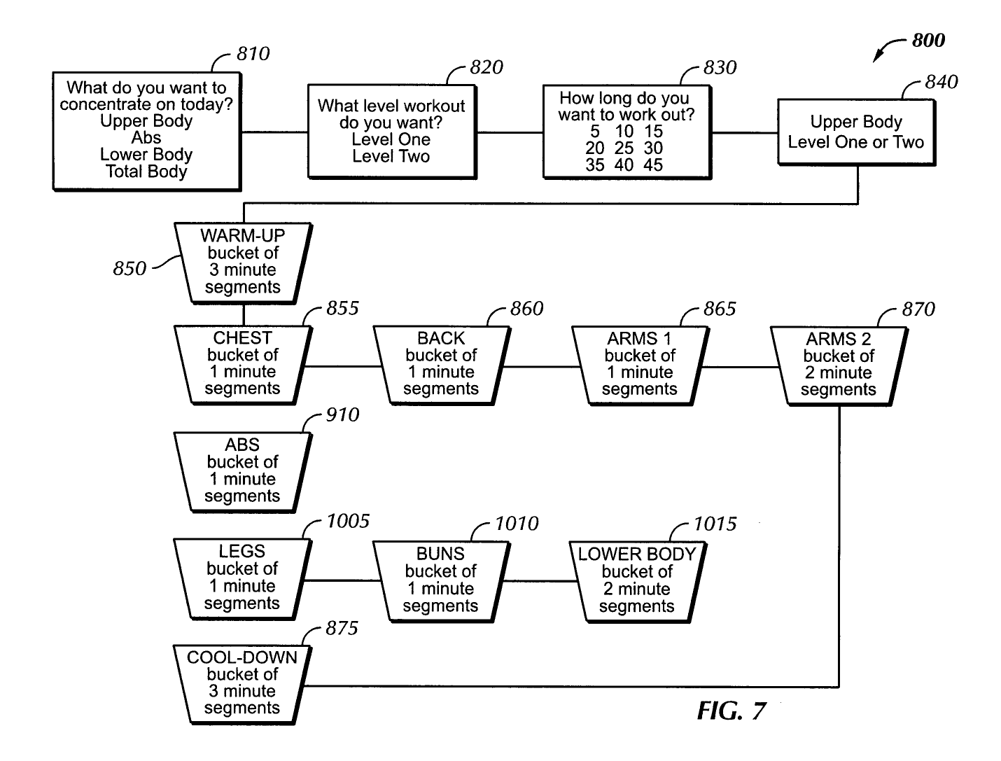

FIG. 7 shows a flow chart of an example in which a user presented with screen 100 selects button 100 “customize your workout”, then in step 810, at screen 200 selects “upper body”, selects “level one” 305 (or “level two” 310) in step 820, and finally, in step 830, at screen 300, selects the length of time that the user wishes to work out. The workout is then determined in step 840, and the workout may begin with a warm-up of, for example, 3-minute segments (of course the digital storage medium may be set up so that the warm-up and cool-down segments are automatically included in all workouts, or, may be set up such that they must be activated by the user). Continuing to steps 855, 860, 865 and 870, the digital storage medium advances to each upper body “bucket” (chest, back, arms 1 and arms 2, respectively) to include a predetermined number of 1-minute segments from each of the “upper body” buckets selected by the user (the term “bucket” is described further below). Specific terminology for each of the buckets herein is merely exemplary. For example, if a level one workout is selected by the user, only one 1-minute segment may be activated from each upper body bucket, whereas if a level two workout is selected by the user, two 1-minute segments will be activated from each upper body bucket so as to extend the workout to a level two intensity. In one embodiment, a level two workout selection activates one segment from each applicable bucket in sequence and then returns to the first selected bucket upon completion of the sequence. The segments selected from each of the buckets are randomly decided, thereby providing a unique workout even if the selections remain the same. While a user may see a same segment more than once in the same workout, the segment will not be shown back-to-back during a single workout. The workout is then completed with a cool-down segment 875, for example, a 3-minute segment.

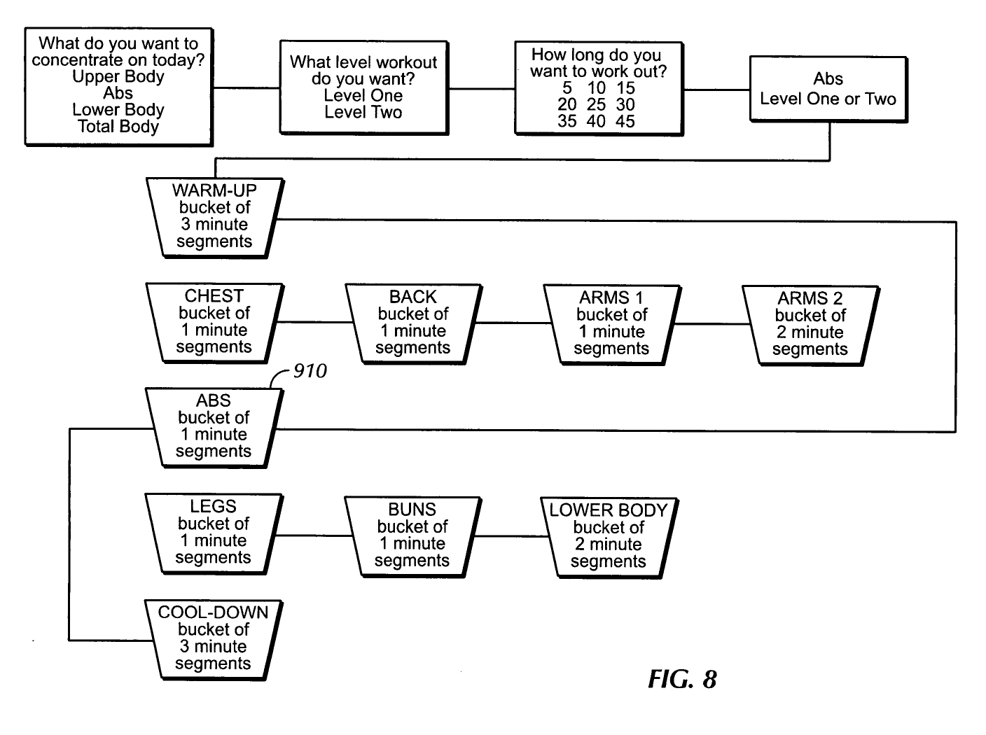

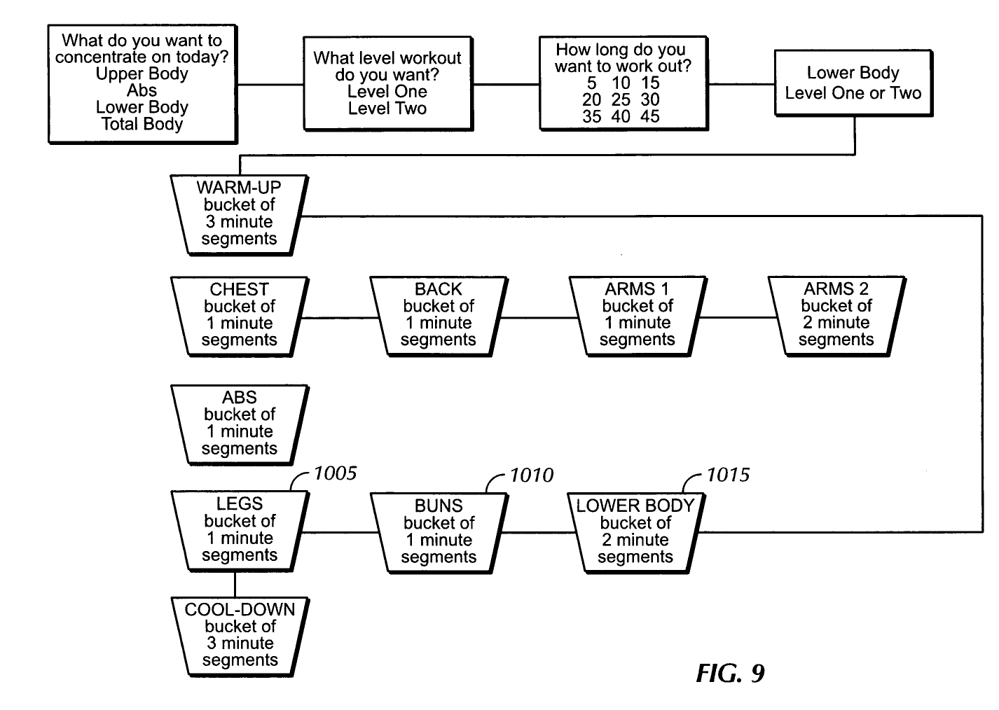

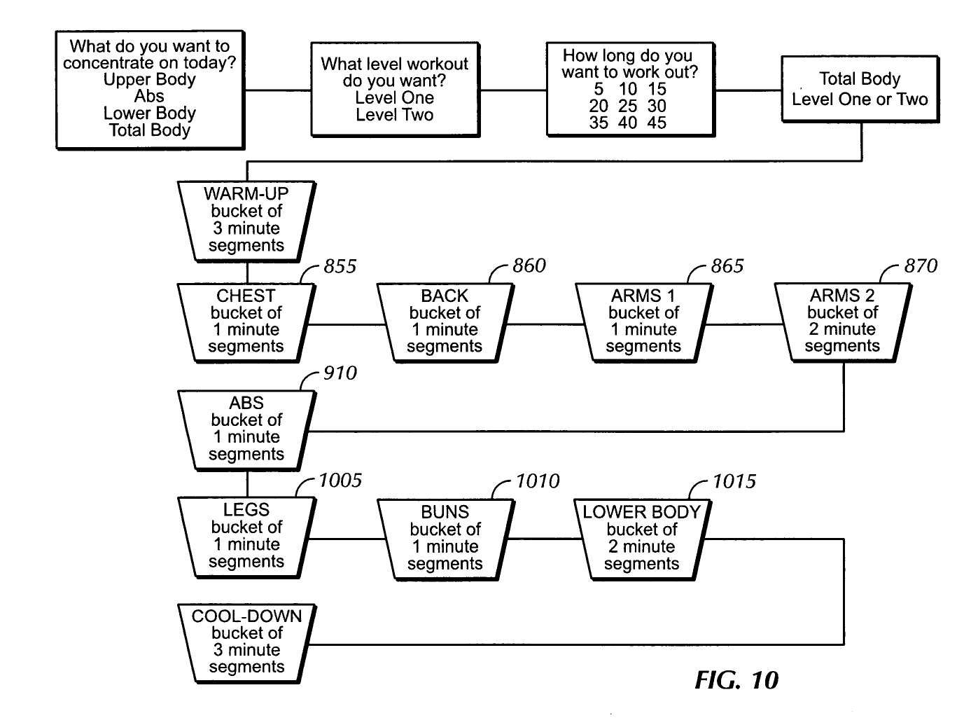

FIG. 7 illustrates the buckets 910 (abdominals), 1005 (legs), 1010 (buttocks) and 1015 (lower body) that were not selected by the user as the desired area of concentration for the customized workout. Therefore, those buckets are not part of the active flow-chart 800 of a workout for an upper body concentration. FIGS. 8-10 however illustrate the flowcharts for an abdominals concentration, a lower body concentration and total body concentration workout, respectively. In particular, FIG. 8 relies upon bucket 910 only to create the desired workout. FIG. 9 relies upon buckets 1005, 1010 and 1015 to obtain workout segments for legs, buttocks and lower body, respectively, for a lower body concentration. FIG. 10 relies upon all of buckets 855 (arms), 860 (back), 865 (chest), 870 (upper body), 910 (abdominals), 1005 (legs), 1010 (buttocks) and 1015 (lower body) to create the “total body concentration” workout.

As discussed above, the authoring architecture of the digital storage medium is built on “buckets”, each of which contains, 1-minute and/or 2-minute exercise segments. For example, there is a bucket of segments for chest exercises, a bucket of segments for back exercises and a bucket of segments for arm exercises. If a viewer determines that he/she wants to do a 20-minute, upper body, level 1 workout, the digital storage medium would extract the appropriate number of segments from each bucket and create a seamless 20-minute workout. Since the digital storage medium will be able to randomly pull from numerous segments within multiple buckets, the consumer will be provided with a customized yet unique workout each time.

In another embodiment, the DVD can be authored such that upon extracting the appropriate number of segments from each bucket, the segments are randomly shuffled, thereby further ensuring a unique customized fresh workout each time.

The proposed method allows a user to customize a workout into many combinations, varying the both the intensity of the workout and the target of the workout—targeting, for example, the upper body, lower body, abdominals or total body. The method proposed is designed to deliver a maximum desired workout in a minimum timeframe. This type off format allows participants to design their own unique customized workouts depending upon the desired area of concentration, the revel of intensity and the duration of the workout. The number of different workout routines is limited only by the number of buckets and the number of (for example, 1 and 2-mirmte) segments contained within the buckets.

In addition, a clock may be included within the digital storage medium (or ‘DVD’) so that a consumer is aware of the total time ‘programmed’ for the customized workout—and the time that has elapsed throughout the program.

The proposed method of navigating allows the customized workout to be performed without further user input after the initial menu selections—i.e., the user is not required to pause to provide further input to advance to a new area of concentration, for example, from the upper body workout to the lower body workout.

As it is understood that embodiments other than the specific embodiments described above may be devised without departing from the spirit and scope of the appended claims, it is intended that the scope of this invention will be governed by the following claims.

1. A method of navigating through an interactive multimedia program stored in a digital storage medium, including a plurality of tracks, the method comprising the steps of:
presenting an interactive selection main menu to a viewer;
presenting a first question to the viewer in response to a selection from the main menu, the question requesting an indication of a first set of parameters desired by the viewer;
presenting a second question to the viewer requesting a second set of parameters desired by the viewer;
presenting a third question to the viewer requesting a third set of parameters desired by the viewer; and
presenting a plurality of the tracks in a sequential order determined at least in part by the viewer selections to the first, second and third questions,
wherein each of the plurality of tracks is associated with at least one of a plurality of predefined categories.

2. The method of claim 1, wherein the digital storage medium is a DVD.

3. The method of claim 1, wherein the second question is presented after receiving a viewer selection to the first question, and wherein the third question is presented after receiving a viewer selection to the second question.

4. The method of claim 1, wherein the plurality of tracks presented are randomly selected from within the predefined categories determined based on the viewer selections.

5. The method of claim 1, wherein the plurality of tracks presented comprise a workout video.

6. The method of claim 1, wherein the step of presenting a first question comprises the step of requesting input from the viewer as to a desired area of concentration for the workout.

7. The method of claim 6, wherein the selections provided comprise one or more of the upper body, lower body, abdominals or total body.

8. The method of claim 5, wherein the step of presenting a second question comprises the step of requesting input from the viewer as to a desired level of intensity for the workout.

9. The method of claim 8, wherein the selections provided comprise a level one workout or a level two workout, and wherein the level one workout is less strenuous than the level two workout.

10. The method of claim 5, wherein the step of presenting a third question comprises the step of requesting input from the viewer as to a desired amount of minutes for the workout.

11. The method claim 10, wherein the selections as to the desired amount of minutes presented to the user vary based on the selection made in response to the second question.

12. The method of claim 5, further comprising the step of presenting at least a single warn-up track prior to the workout tracks.

13. The method of claim 5, further comprising the step of presenting at least a single cool-down track subsequent to the workout tracks.

14. The method of claim 12, wherein at least a single warm-up track is selected based on the viewer selections.

15. The method of claim 13, wherein at least a cool-down track is selected based on the viewer selections.

16. The method of claim 12, wherein the warm-up track is randomly selected.

17. The method of claim 13, wherein the cool-down track is randomly selected.

18. The method of claim 7 wherein the predefined categories for the upper body selection include at least one of the arms, back, chest and upper body.

19. The method of claim 7 wherein the predefined categories for the lower body selection include at least one of the legs, buttocks and lower body.

20. A method of navigating through an interactive multimedia program stored in a digital storage medium, said multimedia program including a plurality of tracks, the method comprising the steps of:
presenting an interactive selection main menu to a viewer;
presenting at least a single question to the viewer in response to a selection from the main menu, the question requesting an indication of a set of parameters, relating to the tracks, desired by the user; and
presenting at least a plurality of the tracks associated with at least one of a plurality of predefined categories determined at least in part by the viewer response to the question,
wherein the plurality of tracks within an individual category are randomly presented to the viewer.
